(19) United States
(12) Patent Application Publication
(10) Pub. No.: US 2026/0208546 A1
(43) Pub. Date: Jul. 23, 2026

(54) A SUSPENSION FORK OF A MOTOR-VEHICLE WHEEL MADE BY MEANS OF AN ADDITIVE MANUFACTURING

(71) Applicant: Maserati S.p.A., Modena (IT)

(72) Inventors: Riccardo BERGAMASCHI, Modena (IT); Eleonora CORTELLETTI, Orbassano Torino (IT); Silvano SANDRI, Orbassano Torino (IT)

(21) Appl. No.: 19/137,797

(22) PCT Filed: Nov. 13, 2023
(86) PCT No.: PCT/IB2023/061430

§ 371 Date: Jun. 11, 2025

(30) Foreign Application Priority Data
Dec. 13, 2022 (IT) 102022000025491

(51) Int. Cl. B60G 13/00; B33Y 80/00; B60G 17/019

(52) U.S. Cl. CPC B60G 13/005; B60G 17/019; B33Y 80/00; B60G 2204/112; B60G 2204/129; B60G 2206/81

(57) ABSTRACT

A suspension of a motor-vehicle wheel comprising includes a suspension fork connected respectively at its opposite ends to a shock absorber unit and an oscillating rod. The suspension also includes at least one acquisition sensor configured to acquire vehicle dynamics data to be transmitted to an electronic control unit. The suspension fork is made in a single piece by means of an additive manufacturing technology, and the single piece includes one or more fastening seats integrated with the fork body, to fasten the sensor to the fork body.

### FIELD OF THE INVENTION

The present invention refers to a suspension of a motor-vehicle wheel comprising:
a suspension fork connected respectively at its opposite ends to an oscillating rod and a shock absorber unit,
at least one acquisition sensor configured to acquire vehicle dynamics data to be transmitted to an electronic control unit, so as to activate one or more active systems on board the vehicle to improve overall driving safety.

### PRIOR ART

A suspension of the type indicated above, commonly used in the art, is illustrated in the enlarged scale perspective view of FIG. 1. Purely by way of example, the suspension 1 illustrated is a suspension assembly of a front wheel of a motor-vehicle, comprising a wheel support 2, a shock absorber unit 3, and a lower oscillating rod 4. The suspension assembly 1 further comprises a suspension fork 5 having an elongated body connected respectively at its opposite ends to the lower oscillating rod 4 and the shock absorber unit 3. More particularly, the suspension fork 5 comprises an upper portion 6 defining a seat for receiving and fixing the shock absorber unit 3 at its lower end 3′. An elongated body extends from the upper portion 6, which ends with two mutually spaced arms 7, extended along a substantially vertical direction with reference to the configuration mounted on the vehicle. At the lower end of each arm 7 a fastening seat is provided to fix the lower oscillating rod 4, in particular by connecting the seats to an elastic bush 8 carried by the oscillating rod 4. It should be noted that the present invention is equally applicable to a suspension assembly with a single-leg fork or parallel leg fork.

Again with reference to FIG. 1, reference 9 indicates an acquisition sensor configured to acquire data useful for vehicle dynamics to be transmitted to an electronic control unit, possibly to activate one or more active systems on board the vehicle to improve the overall driving safety. The acquisition sensor 9 is connected indirectly to the fork 5, by means of a support bracket 10 rigidly connected to the fork body. More specifically, the support bracket 10 has an irregular shape having a connecting portion 10′ fixed to the upper portion 6 of the fork 5, by means of a fastening screw 11 also used for connecting the shock absorber unit 3 to the fork 5. The bracket 10 has a conformation with an end portion 10″ extended as a cantilever with respect to the upper portion 6 of the fork body. The sensor 9 is rigidly connected to the end portion 10″ of the bracket 10 by means of connection means, for example one or more fastening screws.

Therefore, in light of what has been described above, the acquisition sensor 9 is installed on the wheel suspension by means of a support bracket (for example made of metallic material) connected to the fork 5 and extended as a cantilever with respect to the fork body.

According to a technique known per se, the suspension forks are made of aluminum and/or steel using traditional processes such as forging, casting or molding. These processes involve the production of a specific mold for the fork and several other molds for any interface components connected to the fork, such as for example the support bracket for fixing the sensor. Furthermore, subsequent mechanical finishing and/or assembly processes are required for the overall production of the suspension system.

The known solution described above is not without various drawbacks.

First of all, the final configuration assembled with the sensor fixed to the bracket lends itself to possible malfunctions in the detection of the signal by the sensor itself, as the bracket which extends as a cantilever with respect to the fork body could be damaged, for example by impact with an external body. Even without a breakage of the bracket or sensor, erroneous data readings by the sensor could still occur, due to micro-displacements of the sensor from the installation position with relative orientation with respect to the fork, for example due to excessive vibrations which reverberate along the body of the bracket, to which the sensor is connected.

Furthermore, the provision of a connection bracket between the sensor and the fork translates into a greater total weight and therefore a greater cost for the production and management of the support components.

Furthermore, the management cost of the components and the high investment cost of the molds for their production have an impact on a high final development cost. In addition to this, any subsequent modification to one or more components implies a modification of the molds with a further increase in overall times and costs.

The subsequent mechanical operations before the final assembly of the system, as well as the assembly operations, also have a negative impact on overall production times and costs, which are therefore not very sustainable, particularly for vehicles with low production volumes.

The present invention therefore starts from the desire to provide a suspension of the type indicated at the beginning of the present description, which is an improvement from various points of view compared to what is currently known, in particular with regard to the simplicity of the assembly cycle and the overall investment cost.

### Object of the Invention

The object of the present invention is to provide a suspension of the type indicated at the beginning of the present description, which is extremely effective for connecting an acquisition sensor, with relatively simple means and sustainable costs.

A further object of the invention is to provide such a suspension, in order to optimize the number of components, the reliability of the sensor and the simplicity of assembly.

A further object of the invention is to provide such a suspension, so as to optimize overall investment times and costs, making it compatible in particular for vehicles with low production volumes.

A further object of the invention is to provide such a suspension, so as to be able to produce modified components for further vehicle models, minimizing additional development costs.

### SUMMARY OF THE INVENTION

According to one or more embodiments, the above-mentioned objects are achieved through a suspension of a motor-vehicle wheel having the features specifically set out in claims 1-8.

According to one or more embodiments, the above-mentioned objects are achieved through a motor-vehicle having the features specifically set out in claim 8.

Further features of the invention are illustrated in the following description.

### BRIEF DESCRIPTION OF THE FIGURES

Further features and advantages of the invention will emerge from the following description with reference to the attached drawings, provided purely by way of non-limiting example, in which:

FIG. 1 is a perspective view illustrating a suspension of a motor-vehicle wheel, according to a per se prior art,

FIG. 2 is an enlarged scale view of an acquisition sensor arranged to be connected to a suspension fork according to an embodiment of the invention,

FIG. 3 is an enlarged scale perspective view illustrating a suspension fork according to an embodiment of the invention, to which the sensor illustrated in the previous figure is connected, and

FIG. 4 illustrates further features of the invention.

### DETAILED DESCRIPTION OF EMBODIMENTS

The following description illustrates various specific details aimed at an in-depth understanding of examples of one or more embodiments. The embodiments may be implemented without one or more specific details, or with other methods, components, materials etc. In other cases, known structures, materials or operations are not shown or described in detail to avoid obscuring various aspects of the embodiments. The reference to “an/one embodiment” within this specification is to indicate that a particular configuration, structure or feature described in connection with the embodiment is included in at least one embodiment. Thus, phrases such as “in an/one embodiment”, possibly present in different places in this description, do not necessarily refer to the same embodiment. Furthermore, particular conformations, structures or features can be combined appropriately in one or more embodiments and/or associated with the embodiments in a different way from as illustrated here, so for example a feature exemplified here in relation to a figure it can be applied to one or more embodiments exemplified in a different figure.

The references illustrated here are for convenience only and therefore do not limit the extent of protection or the scope of the embodiments.

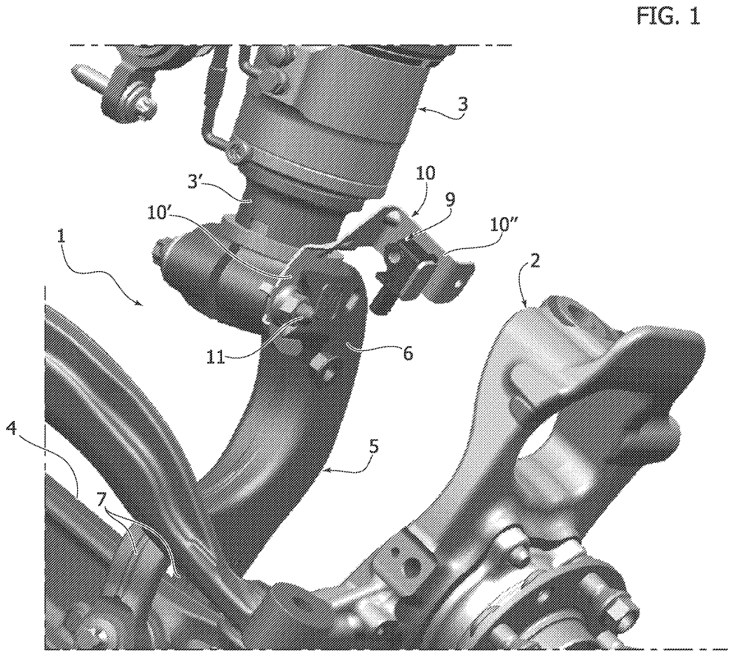

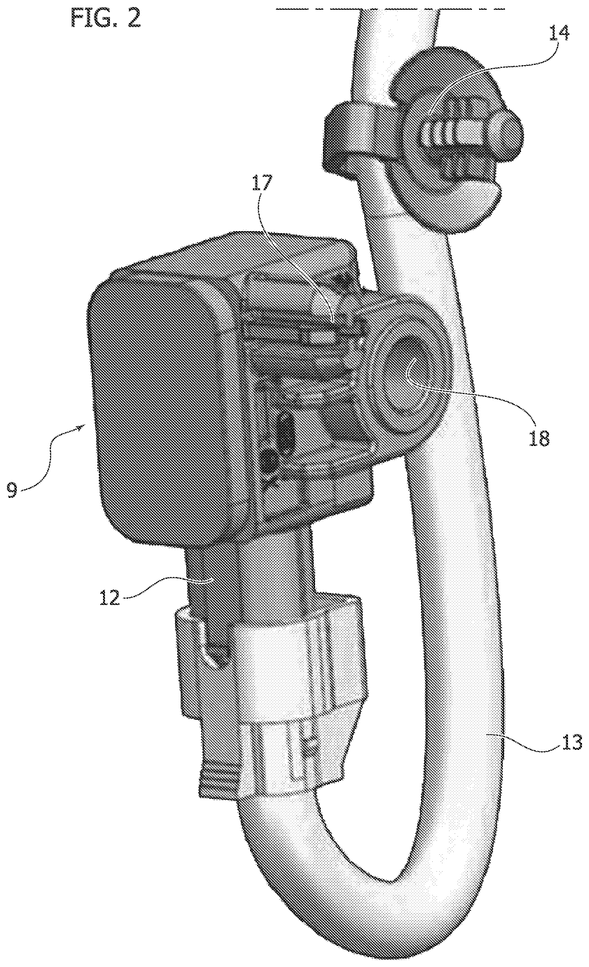

The suspension of the known type illustrated in FIG. 1 has already been described in detail at the beginning of the present description. FIGS. 2-5 illustrate a suspension of a motor-vehicle wheel according to the present invention. The various components in common with the suspension known per se are indicated with the same references.

FIG. 2 is an enlarged scale perspective view illustrating an acquisition sensor 9 according to one embodiment. The sensor 9 comprises an outer case, preferably made of plastic material, designed to be connected to the suspension fork 5. The case comprises a lower end portion 12 connected to an electrical connection wire 13 for transmitting the signal detected by the sensor 9 to an electronic control unit on board the vehicle. Along the electrical connection wire 13 and near the outer case, a fixing clip 14 is joined to the electrical wire 13 for providing a mechanical connection with the fork 5, so as to fix the wire, or at least a proximal portion thereof to the sensor 9, with a specific development path compliant with the dimensions foreseen on board the vehicle.

According to a peculiar feature of the invention, the suspension fork 5 is made by means of an additive manufacturing technology. The expression “additive manufacturing” generally refers to a process known in the art in which use is made of an energy source, such as for example a laser or plasma beam, to selectively melt powder layers or metallic material or plastic material sheets, of various sizes, so as to form, layer after layer, a component of metallic material or plastic material. A device for producing components through additive manufacturing is known for example from document EP 3148784 A1, while European patent application EP 3470248 A1 illustrates an example of application of the construction technique described above in the field of motor-vehicle suspensions.

In one or more embodiments, the suspension fork 8 is made by means of an additive manufacturing technology based on the deposition of material on layers (for example according to powder bed fusion, LPB-F “Laser Powder Bed Fusion”).

According to a further peculiar aspect of the invention, the suspension fork is made in a single piece comprising at least one fastening seat 15 integrated with the fork body 5, to fasten the sensor 9 directly to the fork body.

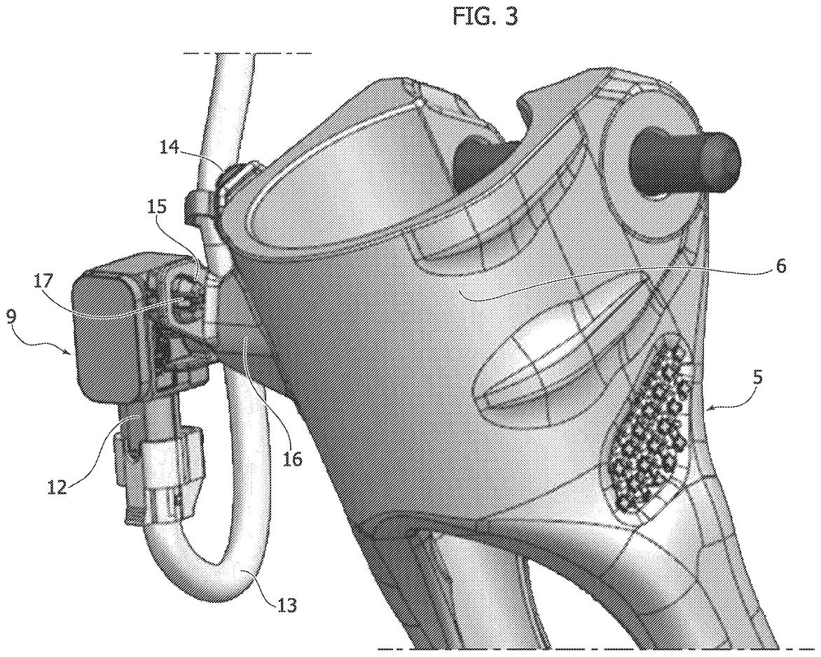

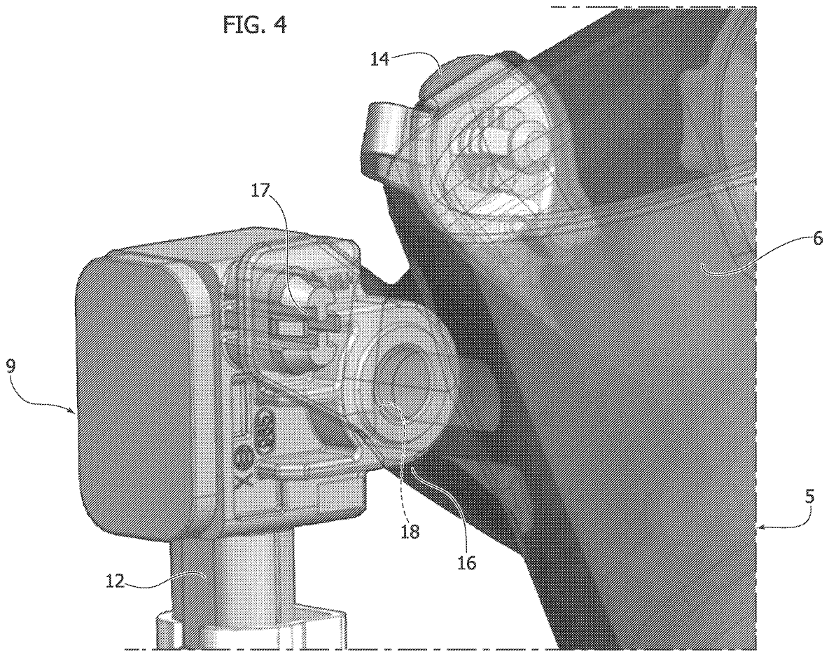

With reference to the embodiment illustrated in FIGS. 3, 4, at least one connecting portion 16 is obtained at the upper portion 6 of the fork body, protruding with respect to the outer continuous surface of the fork body, configured to receive the shock absorber unit 3. On the connecting portion 16 there is a first fastening seat 15 for connecting a respective case portion of the sensor 9. In this regard, the case of the sensor 9 is provided with a fixing pin 17 engaged by interference with the first fastening seat 15 (FIGS. 3, 4). Therefore, by connecting the pin 17 with the first fastening seat 15, the sensor 9 is fixed directly to the fork body without support components interposed between the fork 5 and the sensor 9.

In one or more embodiments, the outer case of the sensor 9 is also provided with a fastening hole 18 for mutual engagement with a fastening screw to be connected to a second fastening seat formed at the upper portion 6 of the fork 5.

In one or more embodiments, on the upper portion 6 of the fork 5 there is also a further fastening seat designed to receive and fix in position the fixing clip 14 joined to the electrical wire 13.

The invention as described above allows the following advantages to be obtained:
proposing a particularly simple and intuitive assembly cycle;
eliminating surface processing subsequent to the forming of the components;
minimizing the possibility of incorrect readings by the sensor;
installing the sensor directly on the fork, so as to simplify the layout of the electrical system;
customizing the shape of the housings depending on the type of sensor selected, without having to carry out costly redesigns; and
optimizing overall investment times and costs, resulting compatible in particular for vehicles with low production volumes.

Of course, notwithstanding the principle of the invention, the construction details and the embodiments may vary widely with respect to what has been described and illustrated purely by way of example, without thereby departing from the scope of the present invention as defined in the attached claims.

1. A suspension of a motor-vehicle wheel comprising:
a suspension fork connected respectively at its opposite ends to a shock absorber unit and an oscillating rod,
at least one acquisition sensor configured to acquire vehicle dynamics data to be transmitted to an electronic control unit, so as to activate one or more active systems on board the vehicle to improve overall driving safety,
wherein said suspension fork is made in a single piece by means of an additive manufacturing technology, wherein said single piece comprises one or more fastening seats integrated with a fork body, to fasten the at least one acquisition sensor to the fork body, in such a way that the at least one acquisition sensor is rigidly connected directly to the fork body, without aid of further support components interposed between the suspension fork and the at least one acquisition sensor.

2. The suspension according to claim 1, wherein the at least one acquisition sensor comprises an outer case arranged to be connected to the suspension fork, wherein said outer case comprises a lower end portion connected to an electrical connection wire for transmitting a signal detected by the at least one acquisition sensor to the electronic control unit.

3. The suspension according to claim 2, wherein along the electrical connection wire, a fixing clip is joined to a section of the electrical connection wire for providing a mechanical connection with the suspension fork.

4. The suspension according to claim 3, wherein at least one connecting portion is formed at an upper portion of the fork body, projecting with respect to an outer continuous surface of the fork body, and wherein a first fastening seat is formed at the at least one connecting portion, for connecting a respective case portion of the at least one acquisition sensor.

5. The suspension according to claim 4, wherein the case of the at least one acquisition sensor is provided with a fixing pin engaged by interference with the first fastening seat.

6. The suspension according to claim 5, wherein a further fastening seat is formed at the upper portion of the suspension fork, arranged to connect the fixing clip.

7. The suspension according to claim 5, wherein the outer case of the at least one acquisition sensor is provided with a fastening hole for mutual engagement with a fastening screw to be connected to a second fastening seat formed at the upper portion of the suspension fork.

8. A motor-vehicle comprising a suspension according to claim 1, wherein said electronic control unit is configured and programmed to receive a plurality of data detected by said at least one acquisition sensor, and wherein said one or more active systems are arranged to improve the overall driving safety, and can be activated by the electronic control unit according to the data received from said at least one acquisition sensor.
